(19) United States
(12) Patent Application Publication
(10) Pub. No.: US 2024/0300731 A1
(43) Pub. Date: Sep. 12, 2024

(54) CONTAINER AND BEVERAGE OR FOODSTUFF PREPARATION SYSTEM COMPRISING THE CONTAINER

(71) Applicant: SOCIETE DES PRODUITS NESTLE S.A., Vevey (CH)

(72) Inventors: ALFRED YOAKIM, St-Legier-La Chiesaz (CH); SIMON MOODIE, Derbyshire (GB)

(21) Appl. No.: 18/579,131

(22) PCT Filed: Jul. 11, 2022
(86) PCT No.: PCT/EP2022/069310

§ 371 Date: Jan. 12, 2024

(30) Foreign Application Priority Data
Jul. 16, 2021 (EP) 21186135.6

(51) Int. Cl. B65D 85/804; A47J 31/36; A47J 31/44

(52) U.S. Cl. CPC B65D 85/8058; A47J 31/369; A47J 31/4492

(57) ABSTRACT

A container (6) arranged for containing a precursor material for use with a machine (4) for preparing a beverage and/or foodstuff, the container comprising: a storage portion (58), a closing member (56), a flange (60) connecting the storage portion and closing member, a machine-readable code (44) storing preparation information for use with a preparation process performed by said machine, and a code carrying member (62), wherein the flange comprises a viewing window (84), the code carrying member (62) extending over the viewing window (84) at a side of the flange that comprises an upper surface (68) of the flange (60), and the code (44) arranged on a flange facing surface (64) of the code carrying member (62), wherein the code (44) is readable from a side of the flange (60) that comprises a lower surface (70) of the flange through the viewing window (84).

### TECHNICAL FIELD

The present disclosure relates generally to electrically operated beverage or foodstuff preparation systems, with which a beverage or foodstuff is prepared from a pre-portioned capsule.

### BACKGROUND

Systems for the preparation of a beverage comprise a beverage preparation machine and a capsule. The capsule comprises a single-serving of a beverage forming precursor material, e.g. ground coffee or tea. The beverage preparation machine is arranged to execute a beverage preparation process on the capsule, typically by the exposure of pressurized, heated water to said precursor material. Processing of the capsule in this manner causes the at least partial extraction of the precursor material from the capsule as the beverage.

This configuration of beverage preparation machine has increased popularity due to 1) enhanced user convenience compared to a conventional beverage preparation machines (e.g. compared to a manually operated stove-top espresso maker) and 2) an enhanced beverage preparation process, wherein: preparation information encoded by a code on the capsule is read by the machine, and; the preparation information is used by the machine to optimise the preparation process in a manner specific to the capsule. In particular, the encoded preparation information may comprise operating parameters selected in the beverage preparation process, including: fluid temperature; fluid pressure; preparation duration, and; fluid volume.

The capsule includes a storage portion for storing the precursor material; a closing member arranged as membrane to close the storage portion, and; a flange formed with the storage portion presents a surface for connection of the membrane. The code is printed to a lower surface of the flange, however the printing process directly onto the flange can be complex. Moreover, the code when exposed on the lower surface of the flange can be subject to damage and/or soiling that could affect its readability.

Therefore, in spite of the effort already invested in the development of said systems further improvements are desirable.

### SUMMARY

The present disclosure provides a container for containing a precursor material for use with a machine for preparing a beverage or foodstuff or a precursor thereof. The container includes: a storage portion, for storage of precursor material, the storage portion having an opening for receiving the precursor material; a closing member (e.g. a membrane) for closing the opening of the storage portion; a flange for connecting the storage portion and closing member, and; a code carrying member. The flange comprises a viewing window, and the code carrying member is arranged to extend over the viewing window at a side of the flange that comprises an upper surface of the flange. The code of the code carrying member is arranged on a flange facing surface of the code carrying member, such that the code is readable from a side of the flange that comprises a lower surface of the flange through the viewing window.

By arranging the code not to be on the flange (e.g. on an underside of the flange) but to be on a separate code carrying member that is visible through the viewing window of the flange, the code is advantageously set back from the underside of the flange and may avoid damage. Moreover, the code may be more conveniently formed since it can be printed on the code carrying member in 2-dimmensions rather than on the 3-dimmensional storage portion and integrated flange.

In embodiments, the code stores preparation information for use with a preparation process performed by said machine, in which the machine is controlled based on the preparation information to prepare the beverage and/or foodstuff or precursor thereof. In embodiments, the code comprises a plurality of elements, the elements encoding a data portion storing the preparation information, and encoding a finder sequence for locating the data portion.

In embodiments, the closing member and the code carrying member are integrally formed. By forming the code on the closing member, e.g. the membrane, the code may be conveniently displayed through the viewing window when the membrane is connected to the flange.

Examples of suitable membranes can be derived from the teachings disclosed herein and examples relating to the containers and/or closing members. Suitable constructional and/or operational details are for instance disclosed in EP2569230.

In embodiments, the code carrying member is arranged as an insert. By arranging the code on an insert separate to the closing member, the code may be precisely aligned in position with the viewing window before the membrane is connected to the flange.

In embodiments, the viewing window is formed as one or more cut-outs. By implementing cut-outs, e.g. though hole perforations in the flange, the visibility of the code from the lower surface may not be impeded by any medium.

In embodiments, the or each cut-out is adjoined by a connecting member that interconnects a peripheral rim of the flange to an interior edge of the flange. The connecting member defines the a radially extending boundary of the cut-out and secures the peripheral rim of the flange to the interior edge of the flange, which is connected to the storage portion.

In embodiments, the connecting member forms a portion of the code. By implementing the connecting member to form a portion of the code, e.g. it may be used as part of the finder sequence, and may be shaped and coloured as one of the elements of the finder sequence, the connecting member does not interrupt the code.

In embodiments, the closing member is adhered to the flange radially inwards of the or each cut-out. By connecting (e.g. by an adhesive) the closing member to the flange on the storage portion side of the cut-outs a hermetic seal may be maintained in spite of the cut-out.

In embodiments, the viewing window comprises an at least partially transparent member. By implementing a transparent member, e.g. a Perspex or other clear material, the code may be viewed through said material. In this way a cut-out which may compromise hermitic sealing of the flange is obviated.

In embodiments, the entire flange is formed from the at least partially transparent member. By forming the entire flange of the transparent member, the transparent member may be more conveniently formed, e.g. rather than just as discrete viewing windows which may otherwise interrupt reading of the code.

In embodiments, the flange and storage portion are integrally formed of the same material. By implementing the flange and storage portion of the transparent material, separate viewing window formations are obviated.

The present disclosure provides a system comprising the container of any preceding embodiment or another embodiment disclosed herein and a machine for preparing a beverage and/or foodstuff or a precursor thereof.

In embodiments, the machine includes: a code reading system to read the code of the container; a processing unit for processing the precursor material of the container, and; electrical circuitry to control the processing unit based on preparation information read from the code. In embodiments, the processing unit includes a container processing unit and a fluid processing system, and; the electrical circuitry is arranged to control the container processing unit and fluid processing system based on the preparation information read from the code. In embodiments, the processing unit is arranged as a loose material processing unit, and; the electrical circuitry is arranged to control the loose material processing unit to process loose precursor material dispensed from the container or arranged in the container based on the preparation information read from the code.

In embodiments, the code reading system is arranged to read the code as the container is rotated about an axis of rotation, and the processing unit is arranged to process the precursor material as the container is rotated about said axis of rotation. Code reading and precursor material processing may be executed concurrently or consecutively.

The present disclosure provides use of the container of any preceding embodiment or another embodiment disclosed herein for a machine for preparing a beverage and/or foodstuff or a precursor thereof.

The present disclosure provides, a method of arranging a code on a container for containing a precursor material for use with a machine for preparing a beverage and/or foodstuff, the method comprising: arranging a code carrying member on a side of a flange that comprises an upper surface of the flange that interconnects a storage portion and a closing member, such that the code is readable from a side of the flange that comprises a lower surface of the flange through a viewing window in the flange.

In embodiments, the method comprises forming the code on the closing member prior to connecting the closing member to the storage portion.

In embodiments, the method comprising forming the code on an insert before arranging the insert on the side of the a flange that comprises an upper surface of the flange.

The method may implement the features of any preceding embodiment, or another embodiment disclosed herein.

The present disclosure provides a container formed by the method of any preceding embodiment, or another embodiment disclosed herein.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Brief Description of Figures, and Claims.

### BRIEF DESCRIPTION OF FIGURES

Aspects, features and advantages of embodiments of the present disclosure will become apparent from the following detailed description of embodiments in reference to the appended drawings in which like numerals denote like elements.

FIG. 1 is a block system diagram showing an embodiment system for preparation of a beverage or foodstuff or a precursor thereof.

FIG. 2 is a block system diagram showing an embodiment machine of the system of FIG. 1.

FIG. 3 is an illustrative diagram showing an embodiment fluid conditioning system of the machine of FIG. 2.

FIGS. 4A and 4B and 5 are illustrative diagrams showing an embodiment container processing system of the machine of FIG. 2.

FIG. 6 is an illustrative diagram showing an embodiment machine of FIG. 2, which comprises a loose material processing unit.

FIG. 7 is a block diagram showing embodiment control electrical circuitry of the machine of FIG. 2.

FIG. 8 is an illustrative diagram showing embodiment container of the system of FIG. 1.

FIG. 9 is flow diagram showing an embodiment preparation process, which is performed by the system of FIG. 1.

FIG. 10 is a magnified view showing a code of the container of FIG. 8.

FIG. 11 is a magnified view showing a flange and a closing member of the container of FIGS. 8 and 10.

FIG. 12 is a plan view showing the container of FIGS. 8, 10 and 11.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein, the term “machine” may refer to an electrically operated device that: can prepare, from a precursor material, a beverage and/or foodstuff, or; can prepare, from a pre-precursor material, a precursor material that can be subsequently prepared into a beverage and/or foodstuff. The machine may implement said preparation by one or more of the following processes: dilution; heating; cooling; mixing; whisking; dissolution; soaking; steeping; extraction; conditioning; infusion; grinding, and; other like process. The machine may be dimensioned for use on a work top, e.g. it may be less than 70 cm in length, width and height. As used herein, the term “prepare” in respect of a beverage and/or foodstuff may refer to the preparation of at least part of the beverage and/or foodstuff (e.g. a beverage is prepared by said machine in its entirety or part prepared to which the end-user may manually add extra fluid prior to consumption, including milk and/or water).

As used herein, the term “container” may refer to any configuration to contain the precursor material, e.g. as a single-serving, pre-portioned amount. The container may have a maximum capacity such that it can only contain a single-serving of precursor material. The container may be single use, e.g. it is physically altered after a preparation process, which can include one or more of: perforation to supply fluid to the precursor material; perforation to supply the beverage/foodstuff from the container; opening by a user to extract the precursor material. The container may be configured for operation with a container processing unit of the machine, e.g. it may include a flange for alignment and directing the container through or arrangement on said unit. The container may include a rupturing portion, which is arranged to rupture when subject to a particular pressure to deliver the beverage/foodstuff. The container may have a closing member, e.g. a membrane, for closing the container. The container may have various forms, including one or more of: frustoconical; cylindrical; disk; hemispherical; packet; other like form. The container may be formed from various materials, such as metal or plastic or a combination thereof. The material may be selected such that it is: food-safe; it can withstand the pressure and/or temperature of a preparation process. The container may be defined as a capsule, wherein a capsule may have an internal volume of 20-100 ml. The capsule includes a coffee capsule, e.g. a Nespresso® capsule (including a Classic, Professional, Vertuo, Dolce Gusto or other capsule). The container may be defined as a receptacle, wherein a receptacle may have an internal volume of 150-350 ml. The receptacle is typically for end user consumption therefrom, and includes a pot, for consumption via an implement including a spoon, and a cup for drinking from. The container may be defined as a packet, wherein the packet is formed from a flexible material, including plastic or foil. A packet may have an internal volume of 150-350 ml or 200-300 ml or 50-150 ml.

As used herein, the term “external device” or “external electronic device” or “peripheral device” may include electronic components external to the machine, e.g. those arranged at a same location as the machine or those remote from the machine, which communicate with the machine over a computer network. The external device may comprise a communication interface for communication with the machine and/or a server system. The external device may comprise devices including: a smartphone; a PDA; a video game controller; a tablet; a laptop; or other like device.

As used herein, the term “server system” may refer to electronic components external to the machine, e.g. those arranged at a remote location from the machine, which communicate with the machine over a computer network. The server system may comprise a communication interface for communication with the machine and/or the external device. The server system can include: a networked-based computer (e.g. a remote server); a cloud-based computer; any other server system.

As used herein, the term “system” or “beverage or foodstuff preparation system” may refer to the combination of any two of more of: the beverage or foodstuff preparation machine; the container; the server system, and; the peripheral device.

As used herein, the term “beverage” may refer to any substance capable of being processed to a potable substance, which may be chilled or hot. The beverage may be one or more of: a solid; a liquid; a gel; a paste. The beverage may include one or a combination of: tea; coffee; hot chocolate; milk; cordial; vitamin composition; herbal tea/infusion; infused/flavoured water, and; other substance. As used herein, the term “foodstuff” may refer to any substance capable of being processed to a nutriment for eating, which may be chilled or hot. The foodstuff may be one or more of: a solid; a liquid; a gel; a paste. The foodstuff may include: yoghurt; mousse; parfait; soup; ice cream; sorbet; custard; smoothies; other substance. It will be appreciated that there is a degree of overlap between the definitions of a beverage and foodstuff, e.g. a beverage can also be a foodstuff and thus a machine that is said to prepare a beverage or foodstuff does not preclude the preparation of both.

As used herein, the term “precursor material” may refer to any material capable of being processed to form part or all of the beverage or foodstuff. The precursor material can be one or more of a: powder; crystalline; liquid; gel; solid, and; other. Examples of a beverage forming precursor material include: ground coffee; milk powder; tea leaves; coco powder; vitamin composition; herbs, e.g. for forming a herbal/infusion tea; a flavouring, and; other like material. Examples of a foodstuff forming precursor material include: dried vegetables or stock as anhydrous soup powder; powdered milk; flour based powders including custard; powdered yoghurt or ice-cream, and; other like material. A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

As used herein, the term “fluid” (in respect of fluid supplied by a fluid conditioning system) may include one or more of: water; milk; other. As used herein, the term “conditioning” in respect of a fluid may refer to a change in a physical property thereof and can include one or more of the following: heating or cooling; agitation (including frothing via whipping to introduce bubbles and mixing to introduce turbulence); portioning to a single-serving amount suitable for use with a single serving container; pressurisation e.g. to a brewing pressure; carbonating; fliting/purifying, and; other conditioning process.

As used herein, the term “processing unit” may refer to an arrangement that can process precursor material to a beverage or foodstuff. It may refer to an arrangement that can process a pre-precursor material to a precursor material. The processing unit may have any suitable implementation, including a container processing unit or a loose material processing unit.

As used herein, the term “container processing unit” may refer to an arrangement that can process a container to derive an associated beverage or foodstuff from a precursor material. The container processing unit may be arranged to process the precursor material by one of more of the following: dilution; heating; cooling; mixing; whisking; dissolution; soaking; steeping; extraction; conditioning; pressurisation; infusion, and: other processing step. The container processing unit may therefore implement a range of units depending on the processing step, which can include: an extraction unit (which may implement a pressurised and/or a thermal, e.g. heating or cooling, brewing process); a mixing unit (which mixes a beverage or foodstuff in a receptacle for end user consumption therefore; a dispensing and dissolution unit (which extracts a portion of the precursor material from a repository, processes by dissolution and dispenses it into a receptacle), and: other like unit.

As used herein, the term “loose material processing unit” may refer to an arrangement that can process loose material of a pre-precursor material to a precursor material. The loose material processing unit may be arranged to process the pre-precursor material by one of more of the following: heating; cooling; grinding; mixing; soaking; conditioning; other processing step. The loose material may be supplied to the loose material processing unit in a container, from which it is extracted and processed.

As used herein, the term “preparation process” may refer to a process to prepare a beverage or foodstuff from a precursor material or to prepare a pre-precursor material from precursor material. A preparation process may refer to the processes electrical circuitry executes to control the container processing unit to process said precursor or pre-precursor material.

As used herein, the term “electrical circuitry” or “circuitry” or “control electrical circuitry” may refer to one or more hardware and/or software components, examples of which may include: an Application Specific Integrated Circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at the machine, or distributed between one or more of: the machine; external devices; a server system.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board machine or distributed as part of the system. As used herein, any machine executable instructions, or computer readable media, may be configured to cause a disclosed method to be carried out, e.g. by the machine or system as disclosed herein, and may therefore be used synonymously with the term method, or each other.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); High-Definition Multimedia Interface (HDMI) or other protocol implementations. The machine may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet.

As used herein, the term “code” may refer to storage medium that encodes preparation information. The code may be an optically readable code, e.g. a bar code. The code may be formed of a plurality of units, which can be referred to as elements or markers.

As used herein, the term “preparation information” may refer to information related to a preparation process. Depending on the implementation of the processing unit said information may vary. The parameters that may be associated container processing unit that comprises a fluid processing system, can include one or more of: fluid pressure; fluid temperature; mass/volumetric flow rate; fluid volume; filtering/purification parameters for the fluid; carbonation parameters for the fluid. The parameters that may be associated container processing unit that comprises a loose material processing unit, can include one or more of: grinding parameters, including intensity; heating temperature. More general parameters can include one or more: container geometric parameters, e.g. shape or volume; the type of precursor; phase identifier, for when a preparation process is split into a series of phases, whereby each phase comprises a set of one or more of any of the aforesaid parameters; duration, including phase duration (e.g. a duration for applying the parameters of a phase or any of the aforementioned parameters generally; and a container identifier, which may for example be used to monitor container consumption for the purpose of container re-ordering or look-up of information from the server system; an expiry date, a recipe identifier, which may be used to lookup a recipe stored on the memory of the machine for use with the container.

### [General System Description]

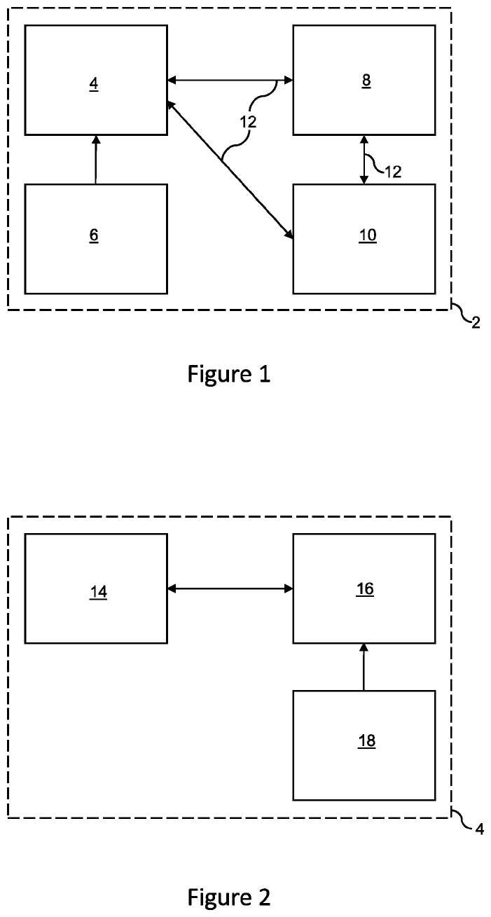

Referring to FIG. 1, the system 2 comprises a machine 4, a container 6, server system 8 and a peripheral device 10. The server system 8 is in communication with the machine 4 via a computer network 12. The peripheral device 10 is in communication with the machine 4 via the computer network 12.

In variant embodiments, which are not illustrated: the peripheral device and/or server system is omitted.

Although the computer network 12 is illustrated as the same between the machine 4, server system 8 and peripheral device 10, other configurations are possible, including: a different computer network for intercommunication between each device: the server system communicates with the machine via the peripheral device rather than directly. In a particular example: the peripheral device communicates with the machine via a wireless interface, e.g. with a Bluetooth™ protocol, and; the server system communicates with the machine via a via a wireless interface, e.g. with a IEE 802.11 standard, and also via the internet.

### [Machine]

Referring to FIG. 2, the machine 4 comprises: a processing unit 14 for processing the precursor material; electrical circuitry 16, and; a code reading system 18.

The electrical circuitry 16 controls the code reading system 18 to read a code (not illustrated in FIG. 2) from the container 6 and determine preparation information therefrom. The electrical circuitry 16 uses the preparation information to control the processing unit 14 to execute a preparation process, in which the precursor material is process to a beverage or foodstuff or a precursor thereof.

### [First Example of Processing Unit]

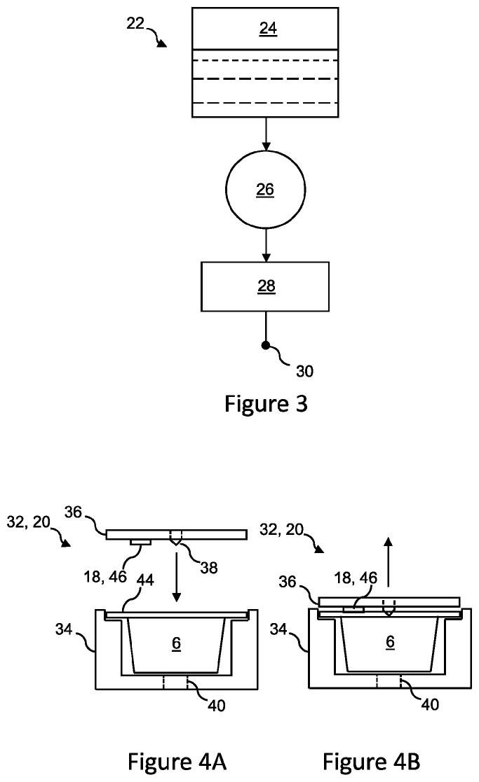

Referring to FIGS. 2 and 3, in a first example of the processing unit 14, said unit comprises a container processing unit 20 and a fluid conditioning system 22.

The container processing unit 20 is arranged to process the container 6 to derive a beverage or foodstuff from precursor material (not illustrated) therein. The fluid conditioning system 22 conditions fluid supplied to the container processing unit 20. The electrical circuitry 16 uses the preparation information read from the container 6 to control the container processing unit 20 and the fluid conditioning system 22 to execute the preparation process.

### [Fluid Conditioning System]

Referring to FIG. 3, the fluid conditioning system 22 includes a reservoir 24; pump 26; heat exchanger 28, and; an outlet 30 for the conditioned fluid. The reservoir 24 contains fluid, typically sufficient for multiple preparation processes. The pump 26 displaces fluid from the reservoir 24, through the heat exchanger 26 and to the outlet 30 (which is connected to the container processing unit 20). The pump 26 can be implement as any suitable device to drive fluid, including: a reciprocating; a rotary pump; other suitable arrangement. The heat exchanger 28 is implemented to heat the fluid, and can include: an in-line, thermo block type heater; a heating element to heat the fluid directly in the reservoir; other suitable arrangement.

In variant embodiments, which are not illustrated: the pump is omitted, e.g. the fluid is fed by gravity to the container processing unit or is pressurised by a mains water supply; the reservoir is omitted, e.g. water is supplied by a mains water supply; the heat exchanger is arranged to cool the fluid, e.g. it may include a refrigeration-type cycle heat pump); the heat exchanger is omitted, e.g. a mains water supply supplies the water at the desired temperature; the fluid conditioning system includes a filtering/purification system, e.g. a UV light system, a degree of which that is applied to the fluid is controllable; a carbonation system that controls a degree to which the fluid is carbonated.

### [Container Processing Unit]

The container processing unit 20 can be implemented with a range of configurations, as illustrated in examples 1-6 below:

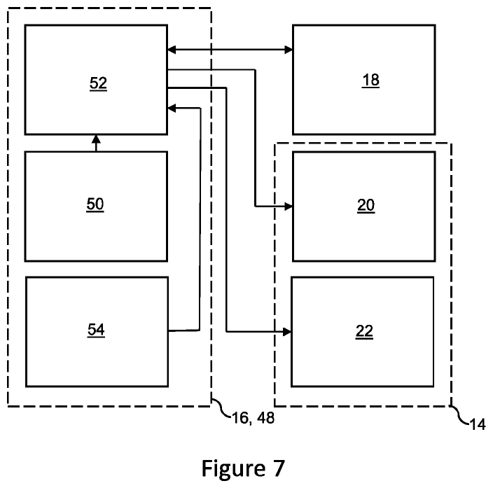

Referring to FIGS. 4A and 4B, a first example of the container processing unit 20 is for processing of a container arranged as a capsule 6 (a suitable example of a capsule is provided in FIG. 7, which will be discussed) to prepare a beverage. The container processing unit 20 is configured as an extraction unit 32 to extract the beverage from the capsule 6. The extraction unit 32 includes a capsule holding portion 34 and a closing portion 36. The extraction unit 32 is movable to a capsule receiving position (FIG. 4A), in which capsule holding portion 34 and a closing portion 36 are arrange to receive a capsule 6. The extraction unit 32 is movable to a capsule extraction position (FIG. 4B), in which the capsule holding portion 34 and a closing portion 36 form a seal around a capsule 6, and the beverage can be extracted from the capsule 6. The extraction unit 32 can be actuator driven or manually movable between said positions.

The outlet 30 of the fluid conditioning system 22 is arranged as an injection head 38 to inject the conditioned fluid into the capsule 6 in the capsule extraction position, typically under high pressure. A beverage outlet 40 is arranged to capture the extracted beverage and convey it from the extraction unit 32.

The extraction unit 32 is arranged to prepare a beverage by the application of pressurised (e.g. at 10-20 Bar), heated (e.g. at 50-98 degrees C.) fluid to the precursor material within the capsule 6. The pressure is increased over a predetermined amount of time until a pressure of a rupturing portion (not illustrated in FIG. 4A, 4B) of the capsule 6 is exceeded, which causes rupture of said portion and the beverage to be dispensed to the beverage outlet 40.

In variant embodiments, which are not illustrated, although the injection head and beverage outlet are illustrated as arranged respectively on the closing portion and capsule holding portion, they may be alternatively arranged, including: the injection head and beverage outlet are arranged respectively on the capsule holding portion and closing portion; or both on the same portion. Moreover, the extraction unit may include both parts arranged as a capsule holding portion, e.g. for capsules that are symmetrical about the flange, including a Nespresso® Professional capsule.

Examples of suitable extraction units are provided in EP 1472156 A1 and in EP 1784344 A1, which are incorporated herein by reference, and provide a hydraulically sealed extraction unit.

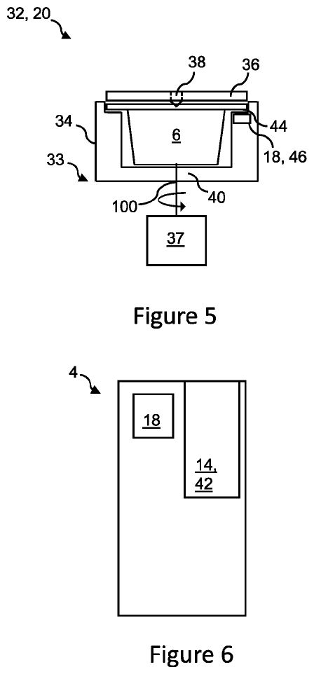

Referring to FIG. 5, in a second example of the container processing unit 20, the extraction unit 32 is as described for the first example, however the extraction unit 32 operates at a lower fluidic pressure and by centrifugation. In particular, the extraction unit 32 includes a rotation mechanism 33 that includes a capsule holing portion 34 to hold the capsule 6 and a drive system 37 to rotate said capsule holder 35.

The outlet 30 of the fluid conditioning system 22 is arranged as on the closing portion 36 as an injection head 38 to inject the conditioned fluid into a centre of the capsule 6 through a closing member of the capsule 6 as will be discussed. The rotation mechanism 33 rotates the capsule to effect transmission of the conditioned fluid radially outwards through precursor material in the capsule 6 and out through peripheral arranged puncture points (not illustrated) in the closing member. An example of a suitable capsule is a Nespresso® Vertuo capsule. A suitable example is provided in EP 2594171 A1, which is incorporated herein by reference.

In a third example, (which is not illustrated) the capsule processing unit operates by dissolution of a beverage precursor that is selected to dissolve under high pressure and temperature fluid. The arrangement is similar to the extraction unit of the first and second example, however the pressure is lower and therefore a sealed extraction unit is not required. In particular, fluid can be injected into a lid of the capsule and a rupturing portion is located in a base of a containment portion of the capsule. An example of a suitable capsule is a Nespresso® Dolce Gusto capsule. Examples of suitable extraction units are disclosed in EP 1472156 A1 and in EP 1784344 A1, which are incorporated herein by reference.

In a fifth example, (which is not illustrated) the container processing unit is arranged as a mixing unit to prepare a beverage or foodstuff precursor that is stored in a container that is a receptacle, which is for end user consumption therefrom. The mixing unit comprises an agitator (e.g. planetary mixer; spiral mixer; vertical cut mixer) to mix and a heat exchanger to heat/cool the beverage or foodstuff precursor in the receptacle. A fluid supply system may also supply fluid to the receptacle. An example of such an arrangement is provided in WO 2014067987 A1, which is incorporated herein by reference.

In a sixth example, (which is not illustrated) the container processing unit is arranged as a dispensing and dissolution unit. The dispensing and dissolution unit is arranged to extract a single serving portion of beverage or foodstuff precursor from a storage portion of the machine (which can include any multi-portioned container including a packet or box). The dispensing and dissolution unit is arranged to mix the extracted single serving portion with the conditioned fluid from the fluid conditioning system, and to dispense the beverage or foodstuff into a receptacle.

### [Second Example of Processing Unit]

Referring to FIG. 6, in a second example of the processing unit 14, said unit comprises a comprises a loose material processing unit 42.

The loose material processing unit 42 is arranged to receive loose pre-precursor material from a container 6 and to process the pre-precursor material to derive the precursor material. The electrical circuitry 16 uses the preparation information read from the container 6 to control the loose material processing unit 42 to execute the preparation process.

A user presents manually the container 6 to a code reading system 18, of the machine 4, to read the code. The user then opens the container 6 and dispenses the pre-precursor material (not illustrated) arranged therein into the loose material processing unit 42. The loose material processing unit 42 processes the loose pre-precursor material to the precursor material.

In a particular example, the pre-precursor material is coffee beans, and the loose material processing unit 42 is arranged to roast and/or grind the coffee beans to provide a precursor material.

In variant embodiments, which are not illustrated, the loose material processing unit is alternatively configured, including: with a dispensing system to open and dispense the pre-precursor from the capsule for subsequent processing (e.g. it may include a cutting tool to cut open the container and an extractor such as a scop to extract the pre-precursor material); the pre-precursor material may be processed in the container and either dispensed from the container by the aforedescribed example or provided to a user in the container.

### [Code Reading System]

Referring to FIGS. 4A and 4B, the code reading system 18 is arranged to read a code 44 arranged on a closing member of the container 6. The code reading system 18 is integrated with the extraction unit 32 of first example of the container processing unit 20. The code 44 is read with the extraction unit 32 in the capsule extraction position (as shown in FIG. 4B).

The code reading system 18 includes an image capturing unit 46 to capture a digital image of the code 44. Examples of a suitable image capturing unit 46 include a Sonix SN9S102; Snap Sensor S2 imager; an oversampled binary image sensor; other like system.

The electrical circuitry 16 includes image processing circuitry (not illustrated) to identify the code in the digital image and extract preparation information. An example of the image processing circuitry is a Texas Instruments TMS320C5517 processor running a code processing program.

Referring to FIG. 5, the code reading system 18 is arranged to read a code 44 from an underside of a flange of the container 6. The code 44 is read based on rotation of the code 44 relative a code reader 46 of the code reading system 18. The code 44 is read with the extraction unit 32 in the capsule extraction position (as shown in FIG. 5), with the rotation mechanism 33 rotating the container 6.

The code reading system 18 includes a code reader 46 to capture a code signal of the code 44. Examples of a suitable image code reader 46 include a photo diode or other electrical componentry that can distinguish between dark an light elements of the code. In variant embodiments, which are not illustrated, the code reader can be implemented as the image capturing unit, as discussed above, or with another suitable reading system.

In variant embodiments, which are not illustrated, the code reading system is separate from the container processing unit including: it is arranged in a channel that the user places the container in and that conveys the container to the container processing unit; it is arranged to read a code on a receptacle, which is positioned to receive a beverage from an beverage outlet of a dispensing and dissolution unit. In further variant embodiments, which are not illustrated, the code reading system is alternatively implemented, e.g. the code reading system is arranged on the machine to read a code of a container that a user manually presents to the image capturing device. In further variant embodiments, which are not illustrated, the code reading system is arranged to read a code at a different location of the container, e.g. on a storage portion or flange portion.

### [Control Electrical Circuitry]

Referring to FIG. 7, the electrical circuitry 16 is implemented as control electrical circuitry 48 to control the processing unit 14 to execute a preparation process. In the embodiment of FIG. 7, for illustrative purposes, the processing unit 14 is exemplified as the first example, which comprises a container processing unit 20 and a fluid supply unit 22.

The electrical circuitry 16, 48 at least partially implements (e.g. in combination with hardware) an: input unit 50 to receive an input from a user confirming that the machine 4 is to execute a preparation process; a processor 52 to receive the input from the input unit 46 and to provide a control output to the processing unit 14, and; a feedback system 54 to provide feedback from the processing unit 54 during the preparation process, which may be used to control the preparation process.

The input unit 50 is implemented as a user interface, which can include one or more of: buttons, e.g. a joystick button or press button; joystick; LEDs; graphic or character LDCs; graphical screen with touch sensing and/or screen edge buttons; other like device; a sensor to determine whether a container has been supplied to the machine by a user.

The feedback system 54 can implement one or more of the following or other feedback control based operations:
a flow sensor to determine a flow rate/volume of the fluid to the outlet 30 (shown in FIG. 3) of the fluid supply system 22, which may be used to meter the correct amount of fluid to the container 6 and thus regulate the power to the pump 26;
a temperature sensor to determine a temperature of the fluid to the outlet 30 of the fluid supply unit 22, which may be used to ensure the temperature of fluid to the container 6 is correct and thus regulate the power to the heat exchanger 28);
a level sensor to determine a level of fluid in the reservoir 24 as being sufficient for a preparation process;
a position sensor to determine a position of the extraction unit 32 (e.g. a capsule extraction position or a capsule receiving position).

It will be understood that the electrical circuitry 16, 44 is suitably adapted for the other examples of the processing unit 14, e.g.: for the second example of the container processing system the feedback system may be used to control speed of rotation of the capsule; for the loose material processing unit the feedback system may be used to implement control of grinding rate and/or a heating temperature.

### [Container]

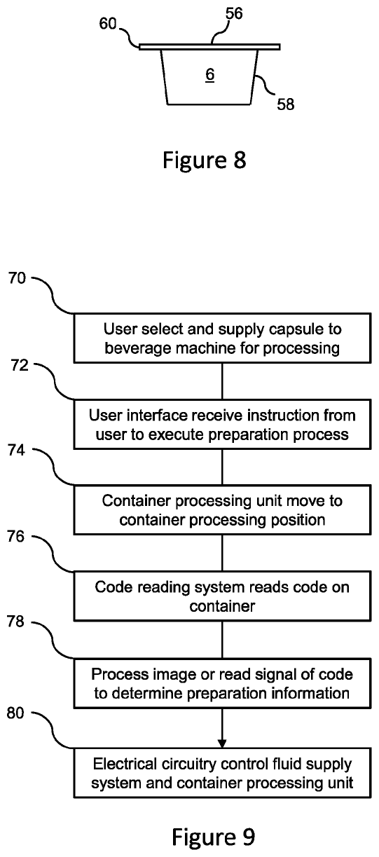

Referring to FIG. 8, an example of a container 6, that is for use with the first example or second example of the processing unit 14 comprises the container 6 arranged as a capsule. The capsule includes: a closing member 56; a storage portion 58, and; a flange portion 60.

The storage portion 58 includes a cavity for storage of the precursor material (not illustrated). The closing member 56 closes the storage portion 58 and comprises a flexible membrane. The flange portion 60 is arranged integrally with the storage portion 58 and presents a flat surface for connecting the closing member 56 to the storage portion 58 to hermetically seal the precursor material. The capsule 6 has a diameter of 2-5 cm and an axial length of 2-4 cm.

In variant embodiments, which are not illustrated, the container can have various shapes including: hemispherical; curved; rectangular in section; frustoconical, and; other like shapes. The closing member may be arranged as a rigid member, rather than a membrane. The container may be formed of two similar or identical storage portions that are connected at a flange, hence the closing member can me omitted. The flange may be connected to the storage portion, hence as separate components. The closing member may connect to the storage portion, hence the flange may be omitted.

Suitable examples of containers and/or closing members in terms of shapes, dimensions and/or materials are know from any of the cartridges, capsules and pods for portioned flavouring ingredients used by Nespresso™ (Original Line, Professional Line, Vertuo Line) and Nestle Dolce Gusto™ and Nestle Special-T™. The materials may thus include metal, for instance aluminium, plastic and/or paper. The materials are preferably biodegradable and/or recyclable. Suitable use, e.g. extraction, processes and systems are also known from Nespresso™, Nestle Dolce Gusto™ or Nestle Special-T™.

Constructional, manufacturing and/or (beverage) extraction details of containers and/or closing members are for instance disclosed in EP 2155021, EP 2316310, EP 2152608, EP2378932, EP2470053, EP2509473, EP2667757 and EP 2528485.

### [Arrangement of Code]

Referring to FIG. 8, the code 44 code is arranged on an exterior surface of the container 6 in any suitable position such that it can be read by the code reading system 18.

Referring to FIG. 8, the code 44 (not illustrated in FIG. 8) may be arranged on one or more of the following positions: the closing member 56; a lower surface of the flange portion 60 that faces away from the closing member 56; the storage portion 58.

### [Preparation Process]

Referring to FIG. 9, the execution of a process for preparing a beverage/foodstuff from precursor material is illustrated:

Block 170: a user supplies a container 6 to the machine 4.

Block 172: the electrical circuitry 16 (e.g. the input unit 50 thereof) receives a user instruction to prepare a beverage/foodstuff from precursor, and the electrical circuitry 16 (e.g. the processor 52) initiates the process.

Block 174: the electrical circuitry 16 controls the processing unit 14 to process the container (e.g. in the first or second example of the container processing unit 20, the extraction unit 32 is moved from the capsule receiving position (FIG. 4A) to the capsule extraction position (FIG. 4B, FIG. 5)).

Block 176: the electrical circuitry 16 controls the code reading system 18 to read the code 44 on the container 6 and provide a digital image of the code or an code signal related to the code.

Block 178: the code processing circuitry of the electrical circuitry 16 processes the digital image to or code signal extract the preparation information.

Block 180: the electrical circuitry 16, based on the preparation information, executes the preparation process by controlling the processing unit 14. In the first example of the processing unit this comprises: controlling the fluid conditioning system 22 to supply fluid at a temperature, pressure, and time duration specified in the preparation information to the container processing unit 20.

The electrical circuitry 16 subsequently controls the container processing unit 20 to move from the capsule extraction position though the capsule ejection position to eject the container 6 and back to the capsule receiving position.

In variant embodiments, which are not illustrated: the above blocks can be executed in a different order, e.g. block 172 before block 170 or block 176 before block 174; some block can be omitted, e.g. where a machine stores a magazine of capsules block 170 can be omitted;

alternatively at blocks 170 to 176 a user presents the code of the container to the code reading system and after it is read opens said container and dispenses the pre-precursor material into the processing unit. Moreover, the container processing unit may be manually moved between the extraction position and capsule receiving position.

Blocks 176 and 178 may be referred to a code reading and processing process. Block 180 may be referred to as the preparation process. The electrical circuitry 16, includes instructions, e.g. as program code, for the preparation process (or a plurality thereof). In an embodiment the processor 52 implements the instructions stored on a memory (not illustrated).

As part of the preparation process, the electrical circuitry 16 can obtain additional preparation information via the computer network 12 from the server system 8 and/or peripheral device 10 using a communication interface (not illustrated) of the machine.

### [Code General Description]

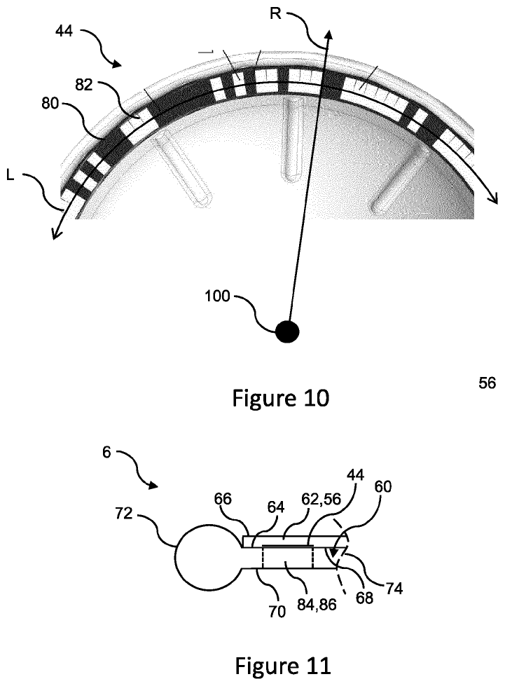

Referring to FIG. 10, the code 44 is formed of a plurality of elements 80. The elements 80 are arranged on a surround 82. The elements 80 are a dark colour (e.g. including one of the following: black, dark blue, purple, dark green) and the surround 82 is a comparatively light colour (e.g. including one of the following: white, light blue, yellow, light green) such that there is sufficient contrast for the image capturing unit 46 to distinguish therebetween. In variant embodiments, which are not illustrated: the elements are a light colour and the surround is a dark colour.

The elements 80 are formed by printing e.g. by means of an ink printer. As an example of printing the ink may be conventional printer ink and the substrate may be the container outer surface including one of the closing member, flange or storage portion, or a separate substrate, which is connected to the container. In variant embodiments, which are not illustrated, the elements are alternatively formed, including by embossing, engraving or other suitable means.

The elements 80 have various shapes as will be discussed. As used herein the term “shape” in respect of the elements may refer to an exact shape or an approximation of the actual shape, which can occur to a printing or other manufacturing variations in precision.

The elements 80 are arranged to be read sequentially when the container is rotated about an axis of rotation 100 (as also illustrated in FIG. 5). The elements 80 of the code 44 are arranged on a circumferentially extending virtual line L.

### [Code Encoding]

The elements 80 encode a data portion for storing the preparation information, and encode a finder sequence for locating the data portion. The elements 80 are encoded as a bit code, wherein the absence or presence of an element encodes a logical 1 or a 0.

The finder sequence (not illustrate) comprises a predefined reserved sequence of logical 1s and/or 0s, which is identifiable when processing the code. The data sequence is arranged at a known position with respect to the finder sequence, e.g. immediately after or distributed within the finder sequence. Hence with the finder sequence located, the data sequence can then be located read and decoded. The data sequence may be decoded based on a rule stored on the electrical circuitry 16 (e.g. via electronic memory) of the machine 2. A specific example of such a code is provide in EP 2594171 A1.

### [Container Formation]

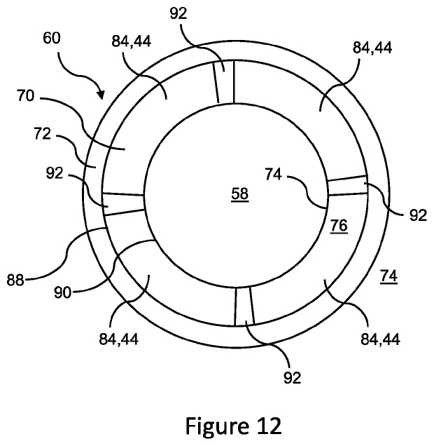

Referring to FIGS. 11 and 12, which is a more detailed example that implements the features discussed in association with the embodiments of FIGS. 8 and 10.

The container 6 comprises a code carrying member 62, which in the embodiment is the membrane 56. The membrane 56 includes a flange facing side 64 and an exterior facing side 66. The flange 60 includes an upper surface 68 and a lower surface 70. The flange 60 includes an outer rim 72 and an inner edge 74 that adjoins the storage portion 58. The code 44 is formed on the flange facing side 64 of the membrane 56 at a position that overlaps the upper surface 68 of the flange 60.

In variant embodiments, which are not illustrated, the code carrying member is a separate member to the membrane, e.g. it is arranged on a separate insert which is positioned between the membrane and flange.

The flange 60 includes a viewing window 84. The code carrying member 62 is arranged to extend over the viewing window 84 such that the code 44 is readable from a side of the flange 60 that comprises the lower surface 70 through the viewing window 84.

The viewing window is formed four cut-outs 86. The cut-outs 86 are bounded by: an outer circumferentially extending edge 88; an inner circumferentially extending edge 90; and connecting members 92. The connecting members 92 interconnect the outer rim 72 to an inner edge 74.

The connecting members 92 and code 44 are arranged such that an individual repetition of each code is visible through a single cut-out 86.

In variant embodiments, which are not illustrated: the connecting member can form a portion of the code, e.g. the connecting member may be formed of a material with a surface finish to correspond to a dark or light colour of an element and may be dimension to correspond to an element, and; more than one code repetition may be arranged per viewing windows or a single code repetition may be distributed across several viewing windows; although four cut-outs are shown may be any number of cut-outs.

To maintain a hermetic seal around the cut-outs 86, the membrane 56 is adhered to the flange 60 radially inwards of the or each cut-out 86, e.g. around the inner edge 74. Alternatively, the membrane 56 is adhered to the flange 60 around the perimeter of each cut-out 86 and proximal the outer rim 72.

In variant embodiments, which are not illustrated, the cut outs are filled with a transparent member, e.g. Perspex, by an adhesive, through which the code can be read.

In variant embodiments, which are not illustrated, entire flange is formed of the transparent member, e.g. Perspex. By forming the entire flange (including optionally the storage portion too) the cut-outs may be obviated.

A method of forming a container 6 comprises the following steps:

Step 1: arranging a code carrying member 62 over the upper surface 68 of the flange 60.

Step 2: positioning the code 44 of the code carrying member 62 so that the code 44 is readable through the viewing window 8 from a side of the flange 60 that comprises a lower surface 70.

Step 3: connecting the membrane 56 to the flange 60 with an adhesive.

In variant embodiments, the code can be formed on the code carrying member after step 3 by printing through the viewing window. In this way it may be ensured that the code is aligned in the correct position with respect to the viewing window.

It will be appreciated that any of the disclosed methods (or corresponding apparatuses, programs, data carriers, etc.) may be carried out by either a host or client, depending on the specific implementation (i.e. the disclosed methods/apparatuses are a form of communication(s), and as such, may be carried out from either ‘point of view’, i.e. in corresponding to each other fashion). Furthermore, it will be understood that the terms “receiving” and “transmitting” encompass “inputting” and “outputting” and are not limited to an RF context of transmitting and receiving radio waves. Therefore, for example, a chip or other device or component for realizing embodiments could generate data for output to another chip, device or component, or have as an input data from another chip, device or component, and such an output or input could be referred to as “transmit” and “receive” including gerund forms, that is, “transmitting” and “receiving”, as well as such “transmitting” and “receiving” within an RF context.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

### LIST OF REFERENCES

2 System
   4 Machine
      14 Processing unit
         20 Container processing unit (first/second example)
         32 Extraction unit
         34 Capsule holding portion
         36 Closing portion
         38 Injection head
         40 Beverage outlet
         33 Rotation mechanism
         37 Drive system
         22 Fluid conditioning system
         24 Reservoir
         26 Pump
         28 Heat exchanger
         30 Outlet
      42 Loose material processing unit
         16 Electrical circuitry
         48 Control electrical circuitry
         54 Feedback system
         18 Code reading system
         46 Image capturing unit
   6 Container (Capsule)
      56 Closing member (membrane)
         64 Lower surface
         66 Upper surface
      58 Storage portion
      60 Flange portion
         68 Upper surface
         70 Lower surface
         72 Peripheral edge (Rim)
         88 Outer edge
         90 Interior edge
         84, 86 Viewing window (cut-out)
         92 Connection portion
      44 Code
         80 Elements
         L Virtual line
         82 Surround
      100 Axis
      R Radial direction
   8 Server system
   10 Peripheral device
   12 Computer network

1. A container arranged for containing a precursor material for use with a machine for preparing a beverage and/or foodstuff, the container comprising:
a storage portion;
a closing member;
a flange connecting the storage portion and closing member, the storage portion extending in a depth direction from the flange;
a machine-readable code storing preparation information for use with a preparation process performed by said machine;
a code carrying member,
the flange comprises a viewing window,
the code carrying member extending over the viewing window at a side of the flange that comprises an upper surface of the flange, and the code arranged on a flange facing surface of the code carrying member, and
the code is readable from a side of the flange that comprises a lower surface of the flange through the viewing window, and the lower surface is arranged at a greater depth than the upper surface.

2. The container of claim 1, wherein:
the closing member and the code carrying member is integrally formed.

3. The container of claim 1, wherein the viewing window is formed as one or more cut-outs.

4. The container of claim 3, wherein the cut-out is adjoined by a connecting member that interconnects a peripheral rim of the flange to an interior edge of the flange.

5. The container of claim 4, wherein the connecting member forms a portion of the code.

6. The container of claim 3, wherein the closing member is adhered to the flange radially inwards of the or each cut-out.

7. The container of claim 1, wherein the viewing window comprises an at least partially transparent member.

8. The container of claim 6, wherein the entire flange is formed from the at least partially transparent member.

9. The container of claim 1, wherein the flange and storage portion are integrally formed of the same material.

10. A system comprising a container arranged for containing a precursor material for use with a machine for preparing a beverage and/or foodstuff, the container comprising:
a storage portion;
a closing member;
a flange connecting the storage portion and closing member, the storage portion extending in a depth direction from the flange;
a machine-readable code storing preparation information for use with a preparation process performed by said machine;
a code carrying member,
the flange comprises a viewing window,
the code carrying member extending over the viewing window at a side of the flange that comprises an upper surface of the flange, and the code arranged on a flange facing surface of the code carrying member, and
the code is readable from a side of the flange that comprises a lower surface of the flange through the viewing window, and the lower surface is arranged at a greater depth than the upper surface and a machine for preparing a beverage and/or foodstuff, the machine including:
a code reading system to read the code of the container;
a processing unit for processing the precursor material of the container, and;
electrical circuitry to control the processing unit based on preparation information read from the code.

11. (canceled)

12. A method of forming a container for containing a precursor material for use with a machine for preparing a beverage and/or foodstuff, the method comprising:
arranging a code carrying member on a side of a flange that comprises an upper surface of the flange that interconnects a storage portion and a closing member, such that the code is readable from a side of the flange that comprises a lower surface of the flange through a viewing window in the flange, wherein the storage portion extends in a depth direction from the flange, and the lower surface is arranged at a greater depth than the upper surface.

13. The method of claim 12 comprising forming the code on the closing member prior to connecting the closing member to the storage portion.

14. The method of claim 12 comprising forming the code on an insert before arranging the insert on the side of the a flange that comprises an upper surface of the flange.

15. (canceled)

16. The container of claim 1, wherein:
the code carrying member is arranged as an insert.
